(19) United States
(12) Patent Application Publication
(10) Pub. No.: US 2022/0344947 A1
(43) Pub. Date: Oct. 27, 2022

(54) ENERGY STORAGE SYSTEM, BALANCING CONTROL METHOD FOR ENERGY STORAGE SYSTEM, AND PHOTOVOLTAIC POWER SYSTEM

(71) Applicant: HUAWEI DIGITAL POWER TECHNOLOGIES CO., LTD., Shenzhen (CN)

(72) Inventors: Zhipeng WU, Shenzhen (CN); He Zhou, Shanghai (CN); Zhigang Wang, Shanghai (CN)

(21) Appl. No.: 17/726,600

(22) Filed: Apr. 22, 2022

(30) Foreign Application Priority Data
Apr. 23, 2021 (CN) 202110443465.4

(51) Int. Cl. H02J 7/00; H02J 7/02

(52) U.S. Cl. CPC H02J 7/0016; H02J 7/02; H02J 7/0048; H02J 2207/20; H02J 3/381

(57) ABSTRACT

An energy storage system, a balancing control method for an energy storage system, or a photovoltaic power system are disclosed. The energy storage system includes a controller and three power conversion branches. Each power conversion branch includes a power conversion circuit, or each power conversion branch includes at least two power conversion circuits connected in series. A second end of each power conversion circuit is connected to at least one battery cluster, each battery cluster includes at least two energy storage modules connected in series, each energy storage module includes one direct current/direct current conversion circuit and one battery pack, an output end of each battery pack is connected to an input end of a corresponding direct current/direct current conversion circuit, and an output end of each direct current/direct current conversion circuit is connected in parallel to a balancing bus.

### CROSS-REFERENCE TO RELATED APPLICATION

This application claims priority to Chinese Patent Application No. 202110443465.4, filed on Apr. 23, 2021, which is hereby incorporated by reference in its entirety.

### TECHNICAL FIELD

This application relates to the field of energy storage systems, and in particular, to an energy storage system, a balancing control method for an energy storage system, and a photovoltaic power system.

### BACKGROUND

With shortage of energy and aggravation of environmental pollution problems in modern society, electric energy generation manners such as photovoltaic power generation and wind energy generation are currently widely used. In addition, with development of an electrochemical cell technology and a dramatic increase in a production capacity, costs of electrochemical cells decrease, bringing an opportunity for electrochemical cells to participate in electric energy storage of a new energy generation system. Because an energy storage system to which electrochemical cells are applied is characterized by flexibility, charging/discharging controllability, a quick response capability, high energy density, and the like, the energy storage system to which electrochemical cells are applied is increasingly widely used in various steps such as electric energy generation, transmission, transformation, distribution, and consumption, and a capacity of the energy storage system is also increasing. A high-voltage cascaded energy storage system is increasingly valued by the energy storage industry because the high-voltage cascaded energy storage system can implement transformer-free direct access of 6 to 35 kilovolts (KV) and a standalone-system capacity of a level of 5 to 30 megawatts (MW).

However, as a capacity of an energy storage system increases, a quantity of batteries included in a battery cluster increases. Because of inconsistency of electrochemical cells, a large quantity of batteries are integrated into one system. Because of inconsistency of factory performance of batteries and a difference in running conditions of the batteries, states of health (SOH) of the batteries are different, and a Cannikin law of batteries becomes prominent. In other words, a battery with a relatively small SOH first completes charging or discharging, and a battery capacity cannot be fully utilized.

To alleviate the foregoing problem, electric energy of batteries may be balanced. Currently, battery-level passive balancing is mostly used in high-voltage cascaded energy storage systems. A principle of passive balancing is as follows: A balancing resistor is connected in parallel to a to-be-balanced battery by using a switch. After the switch is closed, the balancing resistor consumes electric energy, so that electric energy of the battery and another battery is balanced. A balancing current of passive balancing is usually less than or equal to 1 ampere (A), and a capacity of a battery usually reaches hundreds of ampere hours (Ah). Therefore, it is difficult to achieve quick electric energy balancing only by using a quite small balancing current, in other words, an electric energy balancing capability of this manner is quite limited, and the energy storage system is more susceptible to a Cannikin law of batteries.

### SUMMARY

To resolve the foregoing problem, this application provides an energy storage system, a balancing control method for an energy storage system, and a photovoltaic power system, to improve an electric energy balancing capability of the energy storage system and alleviate impact on the energy storage system that is caused by a Cannikin law of batteries.

According to a first aspect, this application provides an energy storage system. The energy storage system is connected to an alternating current power network. In an electrical valley period, the alternating current power network charges the energy storage system, so that a battery in the energy storage system stores electric energy. In an electrical peak period, the energy storage system outputs an alternating current to the alternating current power network. The energy storage system includes a controller and three power conversion circuits. Each power conversion circuit is configured to output a one-phase alternating current. Therefore, the energy storage system is configured to connect to a three-phase alternating current power network. Each power conversion branch includes one power conversion circuit, and a first end of the power conversion circuit is connected to an alternating current bus. Alternatively, each power conversion branch includes at least two power conversion circuits connected in series, and first ends of the at least two power conversion circuits are connected in series and are then connected to an alternating current bus. A second end of each power conversion circuit is connected to at least one battery cluster. When the energy storage system is charged, the first end of the power conversion circuit is an alternating current input end, and the second end is a direct current output end. When the energy storage system discharges, the first end of the power conversion circuit is an alternating current output end, and the second end is a direct current input end. Each battery cluster includes at least two energy storage modules connected in series, each energy storage module includes one direct current/direct current conversion circuit and one battery pack, each battery pack includes at least two batteries, and the batteries in the battery pack may be connected in series or in series and in parallel. An output end of each battery pack is connected to an input end of a corresponding direct current/direct current conversion circuit, and an output end of each direct current/direct current conversion circuit is connected in parallel to a balancing bus. The power conversion circuit can implement bidirectional power conversion, to be specific, convert a direct current provided by the battery cluster into an alternating current and then transmit the alternating current to the alternating current power network, or convert an alternating current obtained from the alternating current power network into a direct current and then charge the battery cluster. The controller is configured to control a working status of each direct current/direct current conversion circuit, so that electric energy of battery packs in the battery cluster is balanced.

In the solution provided in this application, the balancing bus is added to the second end of the power conversion circuit, and each battery pack is connected to the balancing bus by using one direct current/direct current conversion circuit. The controller controls the working status of each direct current/direct current conversion circuit, so that electric energy of a battery pack is transferred to the balancing bus by using the direct current/direct current conversion circuit, and is then transferred from the balancing bus to another battery pack by using another direct current/direct current conversion circuit. In this way, electric energy of battery packs is balanced. Because battery pack-level electric energy balancing is performed, in comparison with a solution of performing passive balancing on batteries, a balancing current greatly increases and can reach a 100-ampere level, so that an electric energy balancing capability is improved. In addition, the controller simultaneously controls a plurality of direct current/direct current conversion circuits, so that electric energy balancing between a plurality of battery packs can be implemented, thereby further improving the electric energy balancing capability.

In conclusion, in the solution provided in this application, battery pack-level electric energy balancing can be performed, so that an electric energy balancing capability is improved, and impact on the energy storage system that is caused by a Cannikin law of batteries is effectively alleviated.

In a possible implementation, the controller determines that an average value of first parameter values of battery packs is a first average value, determines that each battery pack for which a first deviation between a first parameter value and the first average value is greater than a first preset threshold is a first to-be-balanced battery pack, determines that a battery pack for which a first deviation between a first parameter value and the first average value is less than a second preset threshold is a second to-be-balanced battery pack, and controls a direct current/direct current conversion circuit connected to the first to-be-balanced battery pack and a direct current/direct current conversion circuit connected to the second to-be-balanced battery pack. The first preset threshold is greater than the second preset threshold.

There may be one or more first to-be-balanced battery packs and second to-be-balanced battery packs. Because battery pack-level balancing control is implemented, a balancing current greatly increases.

In a possible implementation, the energy storage system further includes a controllable switch, and the balancing bus is connected to a bus of the battery cluster by using the controllable switch. The controller is further configured to control the controllable switch based on the first parameter values of the battery packs. When the controllable switch is open, a balancing control manner is the same as that in the previous implementation. After the controllable switch is closed, balancing control between the battery pack and the bus of the battery cluster can be further performed.

In a possible implementation, when the energy storage module discharges and a first to-be-balanced battery pack exists, the controller controls the controllable switch to be closed, controls a direct current/direct current conversion circuit corresponding to the first to-be-balanced battery pack to be a current source, and controls a current to flow from the first to-be-balanced battery pack to the bus of the battery cluster. When the energy storage module is charged and a second to-be-balanced battery pack exists, the controller controls the controllable switch to be closed, controls a direct current/direct current conversion circuit corresponding to the second to-be-balanced battery pack to be a current source, and controls a current to flow from the bus of the battery cluster to the first to-be-balanced battery pack. In this way, balancing control between the battery pack and the bus of the battery cluster is implemented.

In a possible implementation, when the energy storage module discharges and at least two first to-be-balanced battery packs exist, the controller determines, based on magnitudes of first deviations corresponding to the first to-be-balanced battery packs, magnitudes of balancing currents of direct current/direct current conversion circuits connected to the first to-be-balanced battery packs. When the energy storage module is charged and at least two second to-be-balanced battery packs exist, the controller determines, based on magnitudes of first deviations corresponding to the second to-be-balanced battery packs, magnitudes of balancing currents of direct current/direct current conversion circuits connected to the second to-be-balanced battery packs. The magnitudes of the balancing currents are positively correlated with the magnitudes of the first deviations.

In other words, when a plurality of battery packs meet a balancing condition, balancing currents are allocated based on magnitudes of first deviations, and a battery pack with a larger first deviation corresponds to a higher balancing current.

In a possible implementation, the controller obtains a difference between a maximum value and a minimum value in first parameter values of battery packs, and when the difference is greater than or equal to a third preset threshold, determines that a battery pack with a maximum first parameter value is a first to-be-balanced battery pack, determines that a battery pack with a minimum first parameter value is a second to-be-balanced battery pack, and controls a direct current/direct current conversion circuit connected to the first to-be-balanced battery pack and a direct current/direct current conversion circuit connected to the second to-be-balanced battery pack.

In this embodiment, the difference between the maximum value and the minimum value in the first parameter values reflects a degree of inconsistency of the battery packs. When the difference is greater than or equal to the third preset threshold, it indicates that in this embodiment, electric energy imbalance between the battery packs is serious, and electric energy balancing needs to be performed.

In a possible implementation, the energy storage system further includes a controllable switch. The balancing bus is connected to a bus of the battery cluster by using the controllable switch, and the controller is further configured to control the controllable switch based on the first parameter values of the battery packs.

In a possible implementation, when the energy storage module discharges and a first to-be-balanced battery pack exists, the controller controls the controllable switch to be closed, controls a direct current/direct current conversion circuit corresponding to the first to-be-balanced battery pack to be a current source, and controls a current to flow from the first to-be-balanced battery pack to the bus of the battery cluster. When the energy storage module is charged and a second to-be-balanced battery pack exists, the controller controls the controllable switch to be closed, controls a direct current/direct current conversion circuit corresponding to the second to-be-balanced battery pack to be a current source, and controls a current to flow from the bus of the battery cluster to the first to-be-balanced battery pack.

In a possible implementation, the second end of each power conversion circuit is connected to at least two battery clusters, and buses of the at least two battery clusters are connected in parallel and are then connected to the balancing bus by using the controllable switch.

In a possible implementation, the controller is further configured to: determine that an average value of first parameter values of the at least two battery clusters is a second average value; and when a second deviation between a first parameter value of a battery cluster and the second average value is greater than a fourth preset threshold, control the controllable switch to be open, control a direct current/direct current conversion circuit of a battery cluster whose first parameter value is greater than the second average value to be a voltage source, control a direct current/direct current conversion circuit of a battery cluster whose first parameter value is less than the second average value to be a current source, and control a current to flow from the battery cluster whose first parameter value is greater than the second average value to the battery cluster whose first parameter value is less than the second average value.

Therefore, electric energy balancing between different battery clusters is implemented, and in this embodiment, a balancing current is relatively high, so that a balancing capability of the energy storage system is improved.

In a possible implementation, the first parameter value is a state of charge (SOC) value or a voltage value.

In a possible implementation, the first parameter value is a state of charge (SOC) value, and the controller is further configured to: determine that an average value of first parameter values of the at least two battery clusters is a second average value; and when a second deviation between a first parameter value of a battery cluster and the second average value is greater than a fourth preset threshold, control the controllable switch to be closed, determine that a battery cluster whose first parameter value is greater than the second average value is a to-be-balanced battery cluster, determine that battery packs that are in the to-be-balanced battery cluster and whose first parameter values are greater than the second average value are third to-be-balanced battery packs, and control direct current/direct current conversion circuits connected to the third to-be-balanced battery packs, so that the third to-be-balanced battery packs discharge.

In a possible implementation, the controller obtains third deviations between first parameter values of the third to-be-balanced battery packs and the second average value, and determines, based on the third deviations, balancing currents of the direct current/direct current conversion circuits connected to the third to-be-balanced battery packs. Magnitudes of the balancing currents of the direct current/direct current conversion circuits connected to the third to-be-balanced battery packs is positively correlated with magnitudes of the corresponding third deviations.

In a possible implementation, the controller includes a first control unit and a second control unit. A quantity of second control units is the same as a quantity of battery packs in the battery cluster. Each second control unit obtains a first parameter value of one battery pack, sends the first parameter value to the first control unit, and controls one corresponding direct current/direct current conversion circuit according to a control instruction sent by the first control unit. The first control unit determines the first to-be-balanced battery pack and the second to-be-balanced battery pack based on obtained first parameter values, and sends control instructions to the second control units.

In a possible implementation, the energy storage system further includes a three-phase alternating current bus, a first end of each of three power conversion branches is connected to a one-phase alternating current bus, and second ends of the three power conversion branches are connected to each other.

In other words, the three power conversion branches are connected to the three-phase alternating current bus through a star connection.

In a possible implementation, the energy storage system further includes a three-phase alternating current bus, and three power conversion branches are separately connected between alternating current buses of every two phases.

In other words, the three power conversion branches are connected to the three-phase alternating current bus through a delta connection.

In a possible implementation, a voltage of the balancing bus is less than or equal to an output voltage of the battery cluster, and is greater than a voltage output by the battery pack to the direct current/direct current conversion circuit, so that a volume and costs of the balancing bus are reduced.

According to a second aspect, this application further provides a balancing control method for an energy storage system. The method is applied to the energy storage system provided in the foregoing embodiment. The method includes: controlling each direct current/direct current conversion circuit, so that electric energy of battery packs in a battery cluster is balanced.

In the method, electric energy balancing between the battery packs is implemented. In comparison with a solution of performing passive balancing on batteries, a balancing current greatly increases and can reach a 100-ampere level, so that an electric energy balancing capability is improved. In addition, a controller simultaneously controls a plurality of direct current/direct current conversion circuits, so that electric energy balancing between a plurality of battery packs can be implemented, thereby further improving the electric energy balancing capability and effectively alleviating impact on the energy storage system that is caused by a Cannikin law of batteries.

In a possible implementation, the controlling each direct current/direct current conversion circuit includes:

determining that an average value of first parameter values of the battery packs is a first average value;

determining that each battery pack for which a first deviation between a first parameter value and the first average value is greater than a first preset threshold is a first to-be-balanced battery pack, and determining that a battery pack for which a first deviation between a first parameter value and the first average value is less than a second preset threshold is a second to-be-balanced battery pack, where the first preset threshold is greater than the second preset threshold; and

controlling a direct current/direct current conversion circuit connected to the first to-be-balanced battery pack and a direct current/direct current conversion circuit connected to the second to-be-balanced battery pack, so that the electric energy of the battery packs in the battery cluster is balanced.

In a possible implementation, the energy storage system further includes a controllable switch, a balancing bus is connected to a bus of the battery cluster by using the controllable switch, and the method further includes:

when an energy storage module discharges and a first to-be-balanced battery pack exists, controlling the controllable switch to be closed, controlling a direct current/direct current conversion circuit corresponding to the first to-be-balanced battery pack to be a current source, and controlling a current to flow from the first to-be-balanced battery pack to the bus of the battery cluster; and

when the energy storage module is charged and a second to-be-balanced battery pack exists, controlling the controllable switch to be closed, controlling a direct current/direct current conversion circuit corresponding to the second to-be-balanced battery pack to be a current source, and controlling a current to flow from the bus of the battery cluster to the first to-be-balanced battery pack.

In a possible implementation, when the energy storage module discharges and at least two first to-be-balanced battery packs exist, the method further includes:

determining, based on magnitudes of first deviations corresponding to the first to-be-balanced battery packs, magnitudes of balancing currents of direct current/direct current conversion circuits connected to the first to-be-balanced battery packs; and

when the energy storage module is charged and at least two second to-be-balanced battery packs exist, the method further includes:

determining, based on magnitudes of first deviations corresponding to the second to-be-balanced battery packs, magnitudes of balancing currents of direct current/direct current conversion circuits connected to the second to-be-balanced battery packs, where the magnitudes of the balancing currents are positively correlated with the magnitudes of the first deviations.

In a possible implementation, the controlling each direct current/direct current conversion circuit includes:

obtaining a difference between a maximum value and a minimum value in first parameter values of the battery packs;

when the difference is greater than or equal to a third preset threshold, determining that a battery pack with a maximum first parameter value is a first to-be-balanced battery pack, and determining that a battery pack with a minimum first parameter value is a second to-be-balanced battery pack; and

controlling a direct current/direct current conversion circuit connected to the first to-be-balanced battery pack and a direct current/direct current conversion circuit connected to the second to-be-balanced battery pack, so that the electric energy of the battery packs in the battery cluster is balanced.

In a possible implementation, the energy storage system further includes a controllable switch, a balancing bus is connected to a bus of the battery cluster by using the controllable switch, and the method further includes:

when an energy storage module discharges and a first to-be-balanced battery pack exists, controlling the controllable switch to be closed, controlling a direct current/direct current conversion circuit corresponding to the first to-be-balanced battery pack to be a current source, and controlling a current to flow from the first to-be-balanced battery pack to the bus of the battery cluster; and

when the energy storage module is charged and a second to-be-balanced battery pack exists, controlling the controllable switch to be closed, controlling a direct current/direct current conversion circuit corresponding to the second to-be-balanced battery pack to be a current source, and controlling a current to flow from the bus of the battery cluster to the first to-be-balanced battery pack.

In a possible implementation, a second end of each power conversion circuit is connected to at least two battery clusters, buses of the at least two battery clusters are connected in parallel and are then connected to the balancing bus by using the controllable switch, and the method further includes:

determining that an average value of first parameter values of the at least two battery clusters is a second average value;

when a second deviation between a first parameter value of a battery cluster and the second average value is greater than a fourth preset threshold, controlling the controllable switch to be open; and

controlling a direct current/direct current conversion circuit of a battery cluster whose first parameter value is greater than the second average value to be a voltage source, controlling a direct current/direct current conversion circuit of a battery cluster whose first parameter value is less than the second average value to be a current source, and controlling a current to flow from the battery cluster whose first parameter value is greater than the second average value to the battery cluster whose first parameter value is less than the second average value.

In a possible implementation, the first parameter value is a state of charge (SOC) value or a voltage value.

In a possible implementation, a second end of each power conversion circuit is connected to at least two battery clusters, buses of the at least two battery clusters are connected in parallel and are then connected to the balancing bus by using the controllable switch, the first parameter value is a state of charge (SOC) value, and the method further includes:

determining that an average value of first parameter values of the at least two battery clusters is a second average value;

when a second deviation between a first parameter value of a battery cluster and the second average value is greater than a fourth preset threshold, controlling the controllable switch to be closed; and

determining that a battery cluster whose first parameter value is greater than the second average value is a to-be-balanced battery cluster, determining that battery packs that are in the to-be-balanced battery cluster and whose first parameter values are greater than the second average value are third to-be-balanced battery packs, and controlling direct current/direct current conversion circuits connected to the third to-be-balanced battery packs, so that the third to-be-balanced battery packs discharge.

In a possible implementation, the controlling direct current/direct current conversion circuits connected to the third to-be-balanced battery packs includes:

obtaining third deviations between first parameter values of the third to-be-balanced battery packs and the second average value; and

determining, based on the third deviations, balancing currents of the direct current/direct current conversion circuits connected to the third to-be-balanced battery packs, where magnitudes of the balancing currents of the direct current/direct current conversion circuits connected to the third to-be-balanced battery packs is positively correlated with magnitudes of the corresponding third deviations.

According to a third aspect, this application further provides a photovoltaic power system. The photovoltaic power system includes the energy storage system provided in the foregoing implementations, and further includes a photovoltaic module and a three-phase photovoltaic inverter. The photovoltaic module is configured to: convert optical energy into a direct current, and transmit the direct current to an input end of the three-phase photovoltaic inverter. An output end of the three-phase photovoltaic inverter is connected to a three-phase alternating current bus, and the three-phase alternating current bus is further connected to a power network and an energy storage system. The three-phase photovoltaic inverter is configured to: convert a direct current into a three-phase alternating current, and transmit the three-phase alternating current to the power network by using the three-phase alternating current bus or charge the energy storage system.

The energy storage system of the photovoltaic power system can implement electric energy balancing between battery packs, and a balancing current greatly increases and can reach a 100-ampere level, so that an electric energy balancing capability is improved, and impact on the energy storage system that is caused by a Cannikin law of batteries is effectively alleviated.

### DESCRIPTION OF DRAWINGS

FIG. 1 is a schematic diagram of an example new energy generation system according to this application;

FIG. 2A is a schematic diagram of an energy storage system according to an embodiment of this application;

FIG. 2B is a schematic diagram of another energy storage system according to an embodiment of this application;

FIG. 3 is a schematic diagram of a second end of a power conversion circuit according to an embodiment of this application;

FIG. 4 is a schematic diagram of a second end of another power conversion circuit according to an embodiment of this application;

FIG. 5 is a schematic diagram of a second end of still another power conversion circuit according to an embodiment of this application;

FIG. 6 is a schematic diagram of a second end of yet another power conversion circuit according to an embodiment of this application;

FIG. 7 is a flowchart of a balancing control method for an energy storage system according to an embodiment of this application;

FIG. 8 is a flowchart of another balancing control method for an energy storage system according to an embodiment of this application;

FIG. 9 is a flowchart of still another balancing control method for an energy storage system according to an embodiment of this application;

FIG. 10 is a flowchart of yet another balancing control method for an energy storage system according to an embodiment of this application;

FIG. 11 is a flowchart of still yet another balancing control method for an energy storage system according to an embodiment of this application;

FIG. 12 is a schematic diagram of a photovoltaic power system according to an embodiment of this application;

FIG. 13 is a schematic diagram of another photovoltaic power system according to an embodiment of this application; and

FIG. 14 is a schematic diagram of still another photovoltaic power system according to an embodiment of this application.

### DESCRIPTION OF EMBODIMENTS

To enable a person skilled in the art to better understand the technical solutions provided in embodiments of this application, the following first describes an application scenario of a new energy generation system.

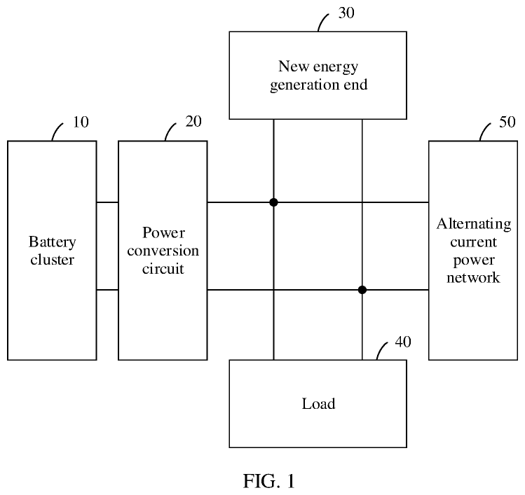

FIG. 1 is a schematic diagram of an example new energy generation system according to this application.

The new energy generation system includes a battery cluster 10, a power conversion circuit 20, a new energy generation end 30, and a load 40.

The new energy generation end 30 is configured to output an alternating current. Because the new energy generation end 30 is characterized by fluctuation and uncertainty, a power yield of the new energy generation end 30 fluctuates. When the alternating current output by the new energy generation end 30 is greater than an electrical requirement of an alternating current power network 50, excess electric energy is converted into a direct current by using the power conversion circuit 20 for charging the battery cluster 10. When the alternating current output by the new energy generation end 30 is less than an electrical requirement of an alternating current power network 50, the power conversion circuit 20 converts, into an alternating current, a direct current output by the battery cluster 10, and then outputs the alternating current to the alternating current power network 50, so that the alternating current power network 50 tends to be stable.

In an example in which the new energy generation end 30 is a photovoltaic power generation end, the new energy generation end 30 includes a photovoltaic module and a direct current (DC)/alternating current (AC) conversion circuit (which may also be referred to as an inverter circuit or an inverter). The photovoltaic module generates a direct current by using optical energy, and the DC/AC conversion circuit converts the direct current into an alternating current, and then outputs the alternating current to the alternating current power network 50 and/or charges the battery cluster 10.

The load 40 is an electrical device of the new energy generation system. The load 40 includes a temperature control system, an air conditioner and a fan. The temperature control system and the battery cluster are usually disposed in an energy storage container. The load 40 may further include another device such as an illumination device. This is not specifically limited in this embodiment of this application.

The battery cluster 10 includes a plurality of battery packs connected in series, and each battery pack includes a plurality of batteries connected in series or connected in series and in parallel. The battery may be a ternary lithium battery, a lead-acid battery, a lithium iron phosphate battery, a lithium-titanate battery, a lead-carbon battery, a supercapacitor, or another type, or a combination of the foregoing types. This is not specifically limited in this application.

Electric energy of batteries in the battery cluster 10 is balanced to alleviate impact on an energy storage system that is caused by a Cannikin law of batteries. However, during implementation of a currently used passive balancing solution, a balancing current is usually less than or equal to 1 A. For a current large battery with a capacity of hundreds of Ah and a high-voltage energy storage system of an MWh level, an electric energy balancing capability of this manner is quite limited. Consequently, when the battery cluster is charged, a charge current of the entire cluster can be limited only based on a battery with a highest SOC or a highest voltage in the batteries of the entire cluster. When the battery cluster discharges, a discharge current of the entire cluster can be limited only based on a battery with a lowest SOC or a lowest voltage in the batteries of the entire cluster. Therefore, a battery capacity cannot be fully utilized.

To resolve the foregoing problem, this application provides an energy storage system, a balancing control method for an energy storage system, and a photovoltaic power system. A balancing bus is added to a second end of a power conversion circuit, and each battery pack is connected to the balancing bus by using one direct current/direct current conversion circuit. A controller controls a working status of each direct current/direct current conversion circuit, so that electric energy of a battery pack is transferred to the balancing bus by using the direct current/direct current conversion circuit, and is then transferred from the balancing bus to another battery pack by using another direct current/direct current conversion circuit. In this way, electric energy of the battery packs is balanced. Because battery pack-level electric energy balancing is performed, a balancing current greatly increases and can reach a 100-ampere level, so that an electric energy balancing capability is improved. In addition, the controller simultaneously controls a plurality of direct current/direct current conversion circuits, so that electric energy balancing between a plurality of battery packs can be implemented, thereby further improving the electric energy balancing capability. Therefore, electric energy balancing can be quickly implemented, and impact on the energy storage system that is caused by a Cannikin law of batteries can be effectively alleviated.

The following describes the technical solutions of this application in detail with reference to the accompanying drawings.

Terms such as “first” and “second” in the following descriptions of this application are merely used for a purpose of description, and cannot be understood as an indication or implication of relative importance or implicit indication of a quantity of indicated technical features.

In this application, unless otherwise specified and limited, the term “connection” should be understood in a broad sense. For example, the term “connection” may be fastening, a detachable connection, or integration, or may be a direct connection, or may be an indirect connection using an intermediate medium.

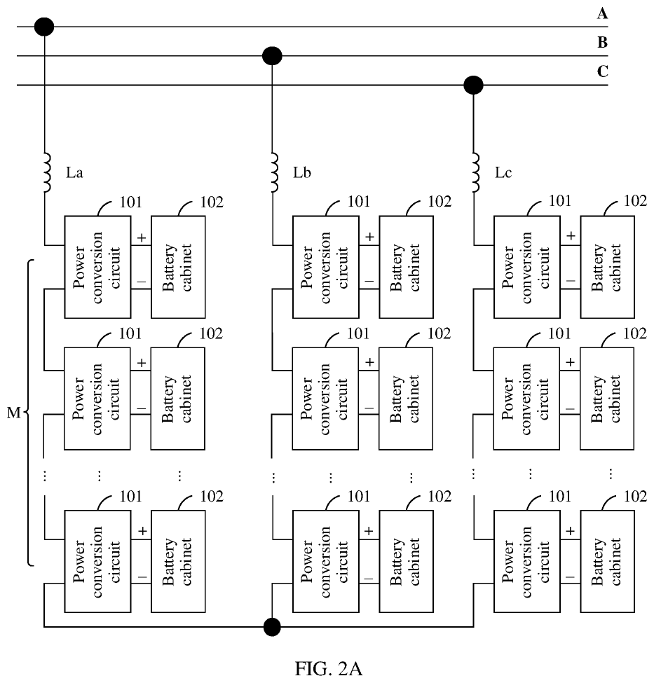

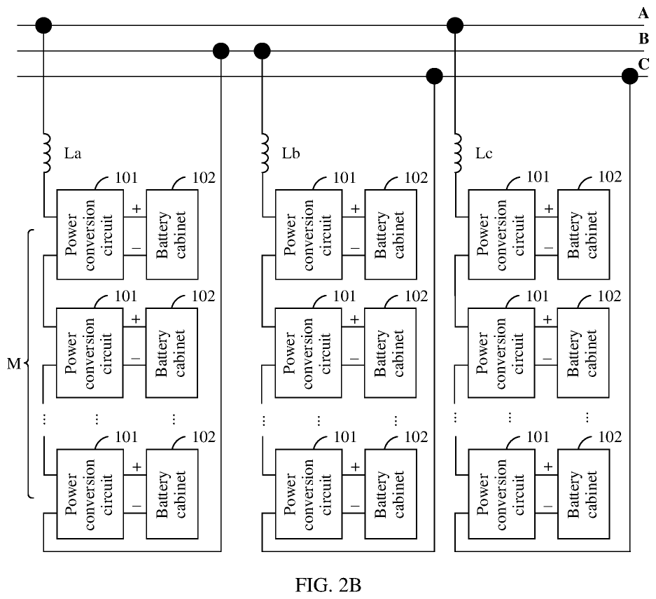

FIG. 2A is a schematic diagram of an energy storage system according to an embodiment of this application.

The energy storage system shown in the figure includes a controller (not shown in the figure) and three power conversion branches.

The energy storage system can access an alternating current power network without a transformer. In some embodiments, a voltage level of the alternating current power network may be up to 6 to 35 KV.

Each power conversion branch includes M power conversion circuits 101, where M is an integer greater than or equal to 1, and a value or quantity of M is related to a voltage level of the energy storage system. In actual application, M is usually greater than 1.

When M is greater than 1, in other words, each power conversion branch includes at least two power conversion circuits 101, first ends of the M power conversion circuits 101 are connected in series.

Specifically, after first ends of M power conversion circuits 101 in a first power conversion branch are connected in series, a formed first end is connected to a phase A of the alternating current power network by using an inductor La, and a formed second end is connected to a neutral point N. After first ends of M power conversion circuits 101 in a second power conversion branch are connected in series, a formed first end is connected to a phase B of the alternating current power network by using an inductor Lb, and a formed second end is connected to the neutral point N. After first ends of M power conversion circuits 101 in a third power conversion branch are connected in series, a formed first end is connected to a phase C of the alternating current power network by using an inductor Lc, and a formed second end is connected to the neutral point N.

A second end of the power conversion circuit 101 shown in the figure is connected to a battery cabinet 102. The battery cabinet 102 is configured to place a battery cluster, and one battery cabinet includes at least one battery cluster. In actual application, the battery cabinet 102 may also be replaced with an open battery shelf, and the open battery shelf is configured to dispose a battery cluster, but needs to meet a corresponding high-voltage insulation requirement.

The power conversion circuit 101 is configured to: convert a direct current provided by the battery cluster into an alternating current and then transmit the alternating current to the alternating current power network, or convert an alternating current obtained from the alternating current power network into a direct current and then charge the battery cluster. Therefore, the power conversion system is a bidirectional direct current/alternating current (AC) converter. Because a port voltage of a battery changes with an energy storage capacity, a port output voltage of the battery cluster is a widely ranging output voltage. Therefore, to match a change range of the port voltage of the battery cluster, the power conversion circuit 101 is usually designed with an input/output capability of a wide range.

A specific implementation of the power conversion circuit 101 is not limited in this embodiment. In some embodiments, the power conversion circuit 101 may use an H-bridge topology. In this embodiment, the power conversion circuit 101 includes a power switch component, and the power switch component may be an insulated gate bipolar transistor (IGBT), a metal-oxide-semiconductor field-effect transistor (MOSFET), a silicon carbide metal-oxide-semiconductor field-effect transistor (SiC MOSFET), a mechanical switch, or any combination of the foregoing.

Taking an implementation in which the three power conversion branches are connected through a star connection as an example, a voltage Uₒᵤₜ of a first end of each power conversion circuit 101 may be determined by using the following formula:

$${U}_{o u t} = \frac{{U}_{g}}{\sqrt{3} \cdot M} , \qquad ( 1 )$$

where

U_{g} is a rated voltage of the power network, and M is a quantity of power conversion circuits 101 in one power conversion branch.

FIG. 2A shows the implementation in which the three power conversion branches of the energy storage system are connected through a star connection. To be specific, the energy storage system further includes a three-phase alternating current bus, a first end of each of the three power conversion branches is connected to a one-phase alternating current bus, and second ends of the three power conversion branches are connected to each other.

It may be understood that in actual application, the three power conversion branches of the energy storage system may be implemented through a delta connection. The following provides detailed descriptions.

FIG. 2B is a schematic diagram of another energy storage system according to an embodiment of this application.

In this embodiment, three power conversion branches are separately connected between alternating current buses of every two phases. In other words, the three power conversion branches are respectively connected between a phase A and a phase B, the phase A and a phase C, and the phase B and the phase C.

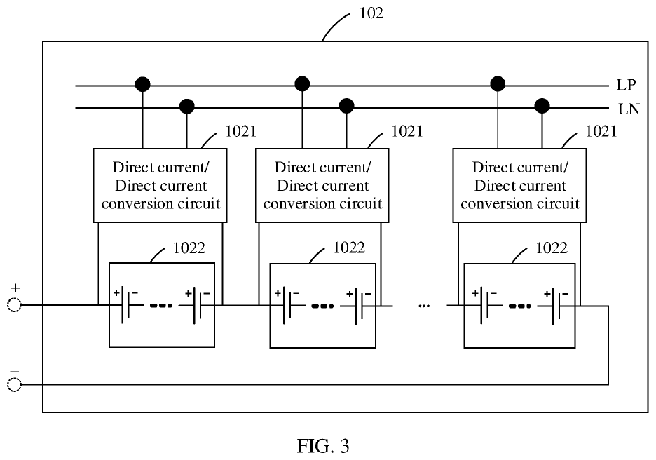

FIG. 3 is a schematic diagram of a second end of a power conversion circuit according to an embodiment of this application.

A battery cabinet at the second end of the power conversion circuit includes one battery cluster, the battery cluster includes at least two energy storage modules connected in series, each energy storage module includes one direct current/direct current conversion circuit 1021 and one battery pack 1022, and each battery pack 1022 includes at least two batteries. The batteries in each battery pack 1022 may be connected in series or connected in series and in parallel. This is not specifically limited in this embodiment of this application.

After positive and negative ports of the battery packs 1022 are sequentially connected in series, a formed positive port (represented by “+” in FIG. 3) of the battery cluster and a formed negative port (represented by “−” in FIG. 3) of the battery cluster are connected to the second end of the power conversion circuit.

In actual application, a total output voltage of the battery cluster is usually designed to be greater than \sqrt{2} times of a voltage Uₒᵤₜ of a first end of the power conversion circuit.

The other group of output ends of each battery pack is further connected to an input end of a corresponding direct current/direct current conversion circuit 1021, and an output end of each direct current/direct current conversion circuit is connected in parallel to a balancing bus. The balancing bus includes a positive bus LP and a negative bus LN.

The direct current/direct current conversion circuit 1021 has a bidirectional voltage step-up/step-down function, to be specific, can step up a voltage provided by the battery pack and then output an obtained voltage to the balancing bus, or step down a voltage provided by the balancing bus and then output an obtained voltage to the battery pack.

The direct current/direct current conversion circuit 1021 has an electrical isolation capability, and meets an insulation requirement of voltages of batteries in the entire cluster. A voltage on a side on which the direct current/direct current conversion circuit 1021 is connected to the battery pack 1022 is consistent with a voltage of the battery pack 1022, and usually ranges from dozens to hundreds of volts. A specific value is related to a quantity of batteries in the battery pack 1022 and a battery connection manner.

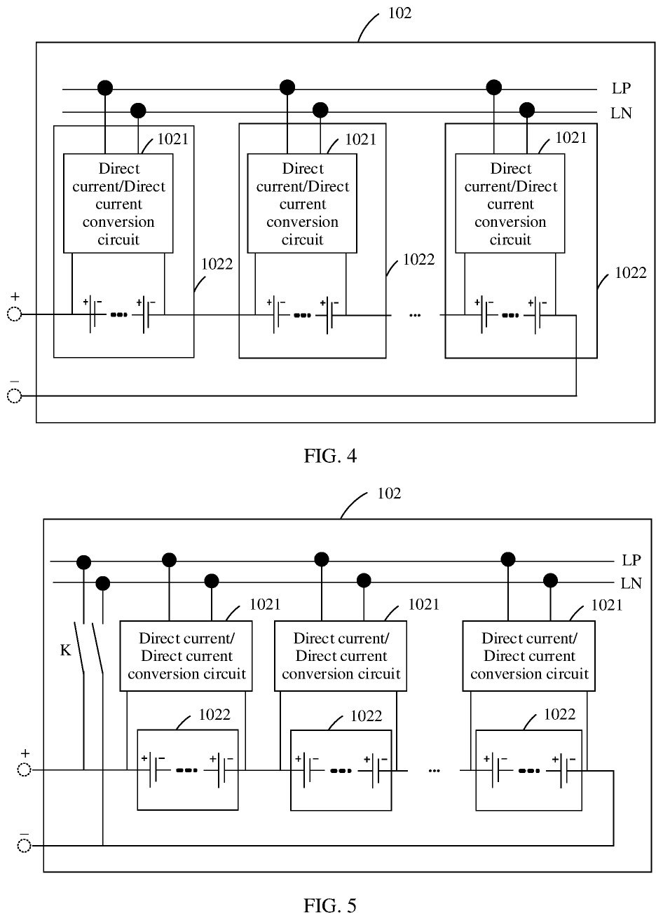

FIG. 4 is a schematic diagram of a second end of another power conversion circuit according to an embodiment of this application.

FIG. 4 differs from FIG. 3 in that a direct current/direct current conversion circuit 1021 is integrated into a battery pack 1022. For other descriptions, refer to the foregoing descriptions.

A controller is configured to control a working status of each direct current/direct current conversion circuit 1021, so that electric energy of battery packs 1022 in a battery cluster is balanced.

In actual application, the controller sends a control signal to a power switch component in each direct current/direct current conversion circuit 1021 to control a working status of the power switch component. In a possible implementation, the control signal is a pulse width modulation (PWM) signal.

The controller may be an application-specific integrated circuit (ASIC), a programmable logic device (PLD), a digital signal processor (DSP), or a combination thereof. The PLD may be a complex programmable logic device (CPLD), a field-programmable gate array (FPGA), a generic array logic (GAL), or any combination thereof.

The controller may be a one-level controller or a multi-level controller. When the controller is a multi-level controller, information exchange may be performed between an upper-level controller and a lower-level controller, and the upper-level controller can control the lower-level controller. The controller may be independently integrated into a printed circuit board (PCB), or the controller may be physically divided into a plurality of parts, and the plurality of parts are separately disposed on PCBs at different locations of the energy storage system. The parts cooperate to implement a control function. This is not specifically limited in this embodiment of this application.

In the solution provided in this embodiment of this application, the balancing bus is added to the second end of the power conversion circuit, and each battery pack is connected to the balancing bus by using one direct current/direct current conversion circuit. The controller controls the working status of each direct current/direct current conversion circuit, so that electric energy of a battery pack is transferred to the balancing bus by using the direct current/direct current conversion circuit, and is then transferred from the balancing bus to another battery pack by using another direct current/direct current conversion circuit. In this way, electric energy of the battery packs is balanced. Because battery pack-level electric energy balancing is performed, in comparison with a solution of performing passive balancing on batteries, a balancing current greatly increases and can reach a 100-ampere level, so that an electric energy balancing capability is improved. In addition, the controller simultaneously controls a plurality of direct current/direct current conversion circuits, so that electric energy balancing between a plurality of battery packs can be implemented, thereby further improving the electric energy balancing capability. Therefore, electric energy balancing can be quickly implemented, and impact on the energy storage system that is caused by a Cannikin law of batteries can be effectively alleviated.

The following describes a process of implementing electric energy balancing with reference to a specific implementation.

A controller may be implemented as a multi-level controller. The controller includes a first control unit and a second control unit.

In some embodiments, the first control unit is a battery control unit (BCU), and the first control unit and a power conversion circuit are integrated together. The second control unit is a battery monitoring unit (BMU), and a quantity of second control units is the same as a quantity of battery packs 1022 in a battery cluster. Each second control unit obtains a first parameter value of one battery pack, sends the first parameter value to the first control unit, and controls one corresponding direct current/direct current conversion circuit according to a control instruction sent by the first control unit. The first control unit is configured to: determine a first to-be-balanced battery pack and a second to-be-balanced battery pack based on obtained first parameter values, and send control instructions to the second control units.

The first parameter value may be a state of charge (SOC) value or a voltage value. In the following descriptions of this application, an example in which the first parameter value is an SOC value is used for description. When the first parameter value is a voltage value, a principle is similar.

The following first describes a principle of controlling, by a controller, an energy storage system to implement electric energy balancing between battery packs.

Still referring to FIG. 3 or FIG. 4, the following describes a working principle of the controller.

A battery cluster includes n battery packs, and second control units obtain SOCᵢ of the corresponding battery packs, where i=1, 2, . . . , and n.

The second control units send obtained SOCᵢ to a first control unit.

The first control unit determines that an average value of the SOC values of the battery packs in the battery cluster is a first average value, and the first average value A1 is determined by using the following formula:

A1=ΣSOC/n (1)

The first control unit determines first deviations Xi between the SOC values of the battery packs and the first average value A1:

Xi=SOCi−ΣSOCi/n (2)

The first control unit determines whether there is currently a battery pack whose corresponding Xi falls beyond a preset threshold range [a, b], where b is a first preset threshold, a is a second preset threshold, and the first preset threshold is greater than the second preset threshold. When all Xi falls within the threshold range [a, b], no electric energy balancing is performed; otherwise, balancing control is enabled.

When balancing control is enabled, the first control unit determines that a battery pack for which a first deviation between an SOC and the first average value A1 is greater than the first preset threshold is a first to-be-balanced battery pack, determines that a battery pack for which a first deviation between an SOC and the first average value A1 is less than the second preset threshold is a second to-be-balanced battery pack, and sends a control instruction to the second control unit, so that the second control unit controls a direct current/direct current conversion circuit connected to the first to-be-balanced battery pack and a direct current/direct current conversion circuit connected to the second to-be-balanced battery pack. It should be noted that the first deviation is not an absolute value, in other words, the first deviation may be positive or negative.

In a possible implementation, during balancing control, the direct current/direct current conversion circuit connected to the first to-be-balanced battery pack may be controlled to be a voltage source for providing a reference voltage of a balancing bus, the direct current/direct current conversion circuit connected to the second to-be-balanced battery pack may be controlled to be a current source, and then magnitudes of a balancing current may be controlled by controlling the direct current/direct current conversion circuit, so that a current of the first to-be-balanced battery pack flows to the second to-be-balanced battery pack through the balancing bus.

In another possible implementation, during balancing control, alternatively, the direct current/direct current conversion circuit connected to the first to-be-balanced battery pack may be controlled to be a current source, and the direct current/direct current conversion circuit connected to the second to-be-balanced battery pack may be controlled to be a voltage source.

There may be one or more first to-be-balanced battery packs, and there may be one or more second to-be-balanced battery packs. In other words, one-to-one balancing, one-to-many balancing, many-to-one balancing, and many-to-many balancing of battery packs may be implemented.

A voltage selected for the balancing bus is determined by a voltage output by the direct current/direct current conversion circuit to the balancing bus. In other words, the voltage of the balancing bus depends on an optimal conversion efficiency point of the direct current/direct current conversion circuit for a purpose of reducing electric energy balancing loss.

In actual application, to reduce a volume and costs of the balancing bus, the voltage output by the direct current/direct current conversion circuit to the balancing bus is greater than a voltage input by the battery pack to the direct current/direct current conversion circuit, and a voltage range of the balancing bus may be controlled to be (the voltage output by the battery pack to the direct current/direct current conversion circuit, a voltage of the battery cluster). In addition, generally, the direct current/direct current conversion circuit is designed to work at the optimal conversion efficiency point.

The foregoing balancing control may be performed when the energy storage system is charged, discharges, or is silent (neither is charged nor discharges). This is not specifically limited in this embodiment of this application.

The following describes another implementation in which a controller controls an energy storage system to implement electric energy balancing between battery packs.

A battery cluster includes n battery packs, and second control units obtain SOCᵢ of the corresponding battery packs, where i=1, 2, . . . , and n.

The second control units send obtained SOCᵢ to a first control unit.

The first control unit obtains a difference d between a maximum value and a minimum value in the SOCs of the battery packs. The difference d is shown in the following formula:

d=SOCₘₐₓ−SOCₘᵢₙ (3)

When the difference d is greater than or equal to a third preset threshold, the first control unit determines that a battery pack with a maximum first parameter value is a first to-be-balanced battery pack, and determines that a battery pack with a minimum first parameter value is a second to-be-balanced battery pack. The first control unit controls a direct current/direct current conversion circuit connected to the first to-be-balanced battery pack and a direct current/direct current conversion circuit connected to the second to-be-balanced battery pack, so that electric energy of the battery packs is balanced.

The following describes a principle of controlling, by a controller, an energy storage system to implement high-power balancing between a battery pack and a battery cluster.

FIG. 5 is a schematic diagram of a second end of still another power conversion circuit according to an embodiment of this application.

FIG. 5 differs from FIG. 3 in that the second end of the power conversion circuit further includes a controllable switch K.

A balancing bus is connected to a bus of a battery cluster by using the controllable switch K, in other words, is connected to an output end of the battery cluster.

The controller further controls the controllable switch K based on a first parameter value of battery packs, to implement high-power balancing between the battery packs and the battery cluster.

When the controllable switch K is open, an implementation of balancing control is consistent with that in the foregoing descriptions.

The following describes a control policy when the controllable switch K is closed.

As described above, the battery cluster includes n battery packs, and second control units obtain SOCᵢ of the corresponding battery packs, where i=1, 2, . . . , and n. The second control units send obtained SOCᵢ to a first control unit. A first control unit determines that an average value of the SOC values of the battery packs in the battery cluster is a first average value A1. The first control unit determines first deviations Xi between the SOC values of the battery packs and the first average value A1, determines that a battery pack for which a first deviation between an SOC and the first average value A1 is greater than a first preset threshold is a first to-be-balanced battery pack, and determines that a battery pack for which a first deviation between an SOC and the first average value A1 is less than a second preset threshold is a second to-be-balanced battery pack.

When an energy storage module discharges and a first to-be-balanced battery pack exists, the first control unit controls the controllable switch to be closed. In this embodiment, a voltage of the balancing bus is clamped to be equal to a voltage of a bus of the battery cluster. The second control unit controls a direct current/direct current conversion circuit corresponding to the first to-be-balanced battery pack to be a current source, and controls a current to flow from the first to-be-balanced battery pack to the bus of the battery cluster.

When the energy storage module is charged and a second to-be-balanced battery pack exists, the first control unit controls the controllable switch to be closed. In this embodiment, the voltage of the balancing bus is clamped to be equal to the voltage of the bus of the battery cluster. The second control unit controls a direct current/direct current conversion circuit corresponding to the second to-be-balanced battery pack to be a current source, and controls a current to flow from the bus of the battery cluster to the first to-be-balanced battery pack.

When a plurality of battery packs meet a balancing condition, the first control unit may indicate magnitudes of balancing currents of direct current/direct current conversion circuits based on magnitudes of first deviations. The following provides detailed descriptions.

When the energy storage module discharges and at least two first to-be-balanced battery packs exist, the first control unit determines, based on magnitudes of first deviations corresponding to the first to-be-balanced battery packs, magnitudes of balancing currents of direct current/direct current conversion circuits connected to the first to-be-balanced battery packs. The magnitudes of the balancing currents are positively correlated with the magnitudes of the first deviations, in other words, a larger first deviation corresponding to the first to-be-balanced battery pack indicates a higher balancing current.

When the energy storage module is charged and at least two second to-be-balanced battery packs exist, the first control unit determines, based on magnitudes of first deviations corresponding to the second to-be-balanced battery packs, magnitudes of balancing currents of direct current/direct current conversion circuits connected to the second to-be-balanced battery packs. The magnitudes of the balancing currents are positively correlated with the magnitudes of the first deviations.

For the implementation in which the first to-be-balanced battery pack and the second to-be-balanced battery pack are determined based on the difference d in the foregoing descriptions, when the energy storage module discharges and a first to-be-balanced battery pack exists, the first control unit controls the controllable switch K to be closed, and in this embodiment, the voltage of the balancing bus is clamped to be equal to the voltage of the bus of the battery cluster, and the second control unit controls a direct current/direct current conversion circuit corresponding to the first to-be-balanced battery pack to be a current source, and controls a current to flow from the first to-be-balanced battery pack to the bus of the battery cluster. When the energy storage module is charged and a second to-be-balanced battery pack exists, the first control unit controls the controllable switch K to be closed. In this embodiment, the voltage of the balancing bus is clamped to be equal to the voltage of the bus of the battery cluster. The second control unit controls a direct current/direct current conversion circuit corresponding to the second to-be-balanced battery pack to be a current source, and controls a current to flow from the bus of the battery cluster to the first to-be-balanced battery pack.

The following describes a principle of controlling, by a controller, an energy storage system to implement high-power balancing between battery clusters. In the following descriptions, an example in which a second end of one power conversion circuit is connected to two battery clusters is used. When a second end of one power conversion circuit is connected to at least three battery clusters, a principle is similar.

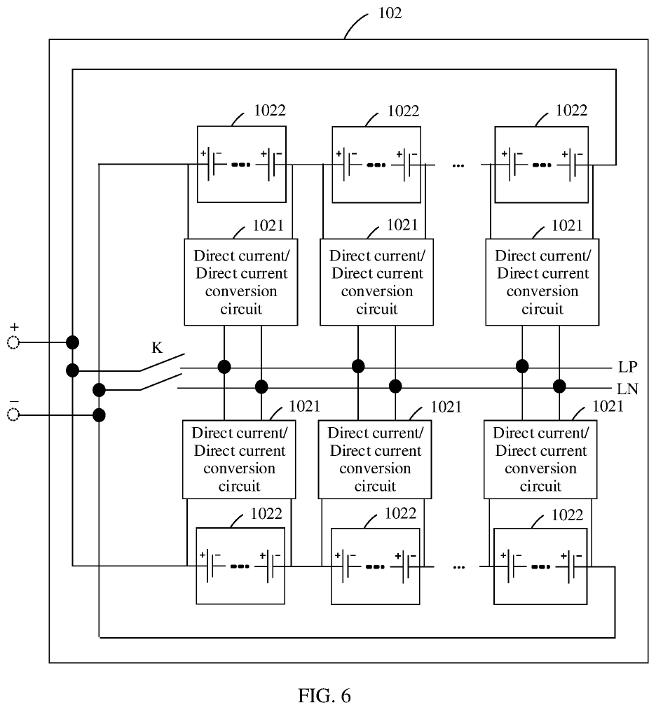

FIG. 6 is a schematic diagram of a second end of yet another power conversion circuit according to an embodiment of this application.

Buses of two battery clusters are connected in parallel and are then connected to a balancing bus by using a controllable switch K.

In this embodiment, a first controller obtains SOC values of the two battery clusters, and the SOC values are SOC₁ and SOC₂.

The first controller determines that an average value of the SOC values of the battery clusters is a second average value A2.

The first control unit determines second deviations Yi between the SOC values of the battery clusters and the second average value A2. When there is a second deviation Yi greater than a fourth preset threshold, it indicates that electric energy between the battery clusters is unbalanced, and balancing control between the battery clusters needs to be performed.

In the present disclosure, in a possible implementation, the first control unit controls the controllable switch K to be open, and a second control unit controls a direct current/direct current conversion circuit of a battery cluster whose SOC value is greater than the second average value to be a voltage source, controls a direct current/direct current conversion circuit of a battery cluster whose SOC value is less than the second average value to be a current source, and controls a current to flow from the battery cluster whose SOC value is greater than the second average value to the battery cluster whose SOC value is less than the second average value, to implement electric energy balancing between the battery clusters.

In the present disclosure, the SOC value may also be replaced with a voltage value.

When a first parameter value is an SOC value, in another possible implementation, the first control unit controls the controllable switch K to be closed, and determines that a battery cluster whose SOC value is greater than the second average value is a to-be-balanced battery cluster. The first control unit further determines that battery packs that are in the to-be-balanced battery cluster and whose SOC values are greater than the second average value are third to-be-balanced battery packs, so that a second control unit controls direct current/direct current conversion circuits connected to the third to-be-balanced battery packs. In this embodiment, the third to-be-balanced battery packs discharge.

When there are two battery clusters at the second end of the power conversion circuit, battery packs in a battery cluster with a higher SOC value is sorted in descending order of SOC values, and battery packs whose SOC values exceed an SOC value of the other battery cluster are third to-be-balanced battery packs.

Specifically, the first controller determines third deviations Zi between SOC values of the third to-be-balanced battery packs and the second average value A2, and determines, based on the third deviations Zi, balancing currents of the direct current/direct current conversion circuits connected to the third to-be-balanced battery packs. Magnitudes of the balancing currents of the direct current/direct current conversion circuits connected to the third to-be-balanced battery packs is positively correlated with magnitudes of the corresponding third deviations Zi. In other words, a larger third deviation Zi indicates a higher balancing current of the direct current/direct current conversion circuit.

In conclusion, in the solution provided in this application, the balancing bus is added to the second end of the power conversion circuit, and each battery pack is connected to the balancing bus by using one direct current/direct current conversion circuit. The controller controls a working status of each direct current/direct current conversion circuit to implement electric energy balancing between battery packs. In addition, the energy storage system can further implement high-power balancing between a battery pack and a battery cluster and high-power balancing between battery clusters, and a balancing current greatly increases and can reach a 100-ampere level, so that an electric energy balancing capability is improved. Therefore, electric energy balancing can be quickly implemented, and impact on the energy storage system that is caused by a Cannikin law of batteries can be effectively alleviated.

In addition, when a bus of a battery cluster is faulty, a battery pack in the battery cluster may continue to exchange energy with the power conversion circuit by using a direct current/direct current conversion circuit, the balancing bus, and the controllable switch K, so that reliability of the energy storage system is further improved.

Based on the energy storage system provided in the foregoing embodiments, an embodiment of this application further provides a balancing control method for an energy storage system. In the method, each direct current/direct current conversion circuit in the energy storage system is controlled, so that electric energy of battery packs in a battery cluster is balanced. The following provides detailed descriptions with reference to the accompanying drawings.

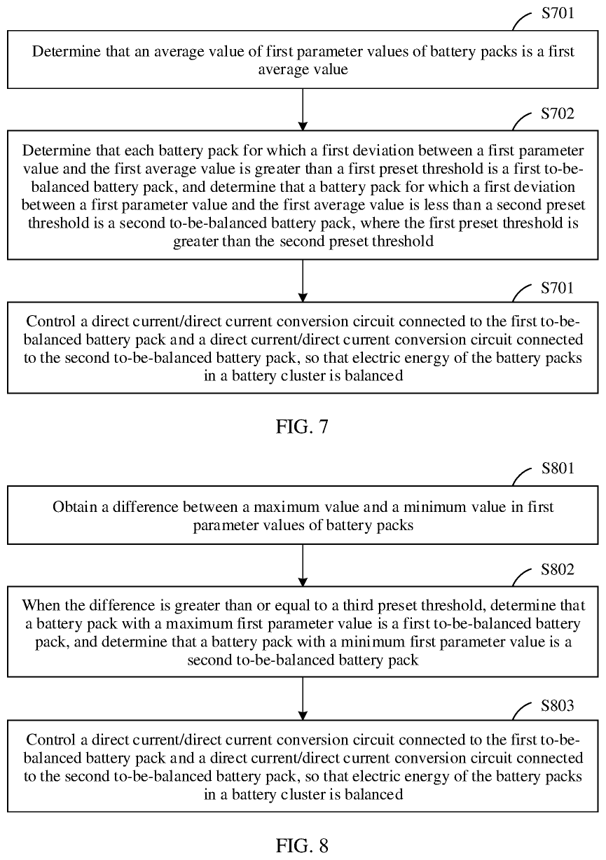

FIG. 7 is a flowchart of a balancing control method for an energy storage system according to an embodiment of this application.

The method shown in the figure includes the following steps.

S701: Determine that an average value of first parameter values of battery packs is a first average value.

The first parameter value may be an SOC value or a voltage value. In the following descriptions of this application, an example in which the first parameter value is an SOC value is used for description.

A battery cluster includes n battery packs, and SOCᵢ of the battery packs is obtained, where i=1, 2, . . . , and n.

It is determined that an average value of the SOC values of the battery packs in the battery cluster is a first average value A1.

S702: Determine that each battery pack for which a first deviation between a first parameter value and the first average value is greater than a first preset threshold is a first to-be-balanced battery pack, and determine that a battery pack for which a first deviation between a first parameter value and the first average value is less than a second preset threshold is a second to-be-balanced battery pack, where the first preset threshold is greater than the second preset threshold.

First deviations Xi between the SOC values of the battery packs and the first average value A1 are determined.

It is determined whether there is currently a battery pack whose corresponding Xi falls beyond a preset threshold range [a, b], where b is the first preset threshold, a is the second preset threshold, and the first preset threshold is greater than the second preset threshold. When all Xi falls within the threshold range [a, b], no electric energy balancing is performed; otherwise, balancing control is enabled.

S703: Control a direct current/direct current conversion circuit connected to the first to-be-balanced battery pack and a direct current/direct current conversion circuit connected to the second to-be-balanced battery pack, so that electric energy of the battery packs in the battery cluster is balanced.

In a possible implementation, during balancing control, the direct current/direct current conversion circuit connected to the first to-be-balanced battery pack may be controlled to be a voltage source for providing a reference voltage of a balancing bus, the direct current/direct current conversion circuit connected to the second to-be-balanced battery pack may be controlled to be a current source, and then magnitudes of a balancing current may be controlled by controlling the direct current/direct current conversion circuit, so that a current of the first to-be-balanced battery pack flows to the second to-be-balanced battery pack through the balancing bus.

In another possible implementation, during balancing control, alternatively, the direct current/direct current conversion circuit connected to the first to-be-balanced battery pack may be controlled to be a current source, and the direct current/direct current conversion circuit connected to the second to-be-balanced battery pack may be controlled to be a voltage source.

There may be one or more first to-be-balanced battery packs, and there may be one or more second to-be-balanced battery packs. In other words, one-to-one balancing, one-to-many balancing, many-to-one balancing, and many-to-many balancing of battery packs may be implemented.

The following describes another method for controlling an energy storage system to implement electric energy balancing between battery packs.

FIG. 8 is a flowchart of another balancing control method for an energy storage system according to an embodiment of this application.

The method shown in the figure includes the following steps.

S801: Obtain a difference between a maximum value and a minimum value in first parameter values of battery packs.

A battery cluster includes n battery packs, and SOCᵢ of the battery packs is obtained, where i=1, 2, . . . , and n.

A difference d between a maximum value and a minimum value in the SOCs of the battery packs is obtained.

S802: When the difference is greater than or equal to a third preset threshold, determine that a battery pack with a maximum first parameter value is a first to-be-balanced battery pack, and determine that a battery pack with a minimum first parameter value is a second to-be-balanced battery pack.

S803: Control a direct current/direct current conversion circuit connected to the first to-be-balanced battery pack and a direct current/direct current conversion circuit connected to the second to-be-balanced battery pack, so that electric energy of the battery packs in the battery cluster is balanced.

In the method provided in this embodiment of this application, a working status of each direct current/direct current conversion circuit is controlled, so that electric energy of a battery pack is transferred to a balancing bus by using the direct current/direct current conversion circuit, and is then transferred from the balancing bus to another battery pack by using another direct current/direct current conversion circuit. In this way, electric energy of the battery packs is balanced. Because battery pack-level electric energy balancing is performed, in comparison with a solution of performing passive balancing on batteries, a balancing current greatly increases and can reach a 100-ampere level, so that an electric energy balancing capability is improved. In addition, a controller simultaneously controls a plurality of direct current/direct current conversion circuits, so that electric energy balancing between a plurality of battery packs can be implemented, thereby further improving the electric energy balancing capability and effectively alleviating impact on an energy storage system that is caused by a Cannikin law of batteries.

The following describes a method for controlling an energy storage system to implement high-power balancing between a battery pack and a battery cluster.

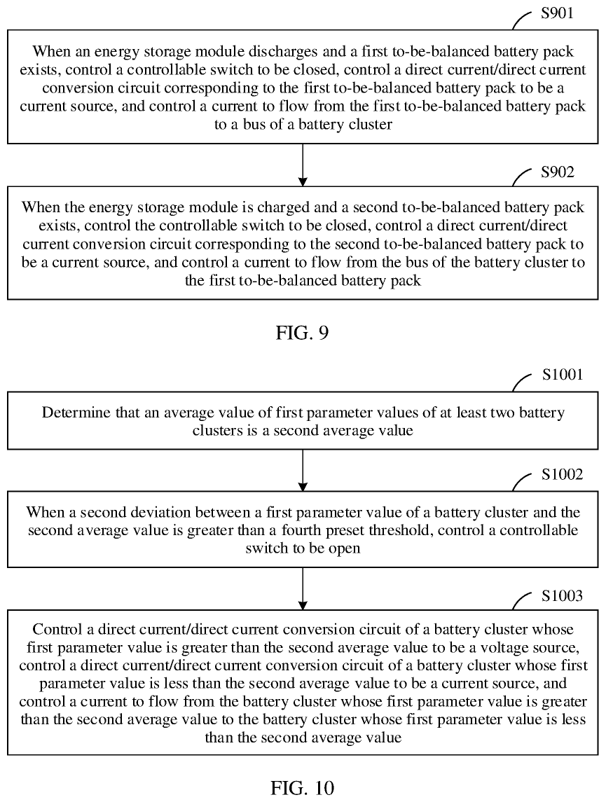

FIG. 9 is a flowchart of still another balancing control method for an energy storage system according to an embodiment of this application.

The method shown in the figure may be implemented based on the method shown in FIG. 7 or FIG. 8, and includes the following steps:

S901: When an energy storage module discharges and a first to-be-balanced battery pack exists, control a controllable switch to be closed, control a direct current/direct current conversion circuit corresponding to the first to-be-balanced battery pack to be a current source, and control a current to flow from the first to-be-balanced battery pack to a bus of a battery cluster.

S902: When the energy storage module is charged and a second to-be-balanced battery pack exists, control the controllable switch to be closed, control a direct current/direct current conversion circuit corresponding to the second to-be-balanced battery pack to be a current source, and control a current to flow from the bus of the battery cluster to the first to-be-balanced battery pack.

In some embodiments, when the energy storage module discharges and at least two first to-be-balanced battery packs exist, the method further includes the following step:

determining, based on magnitudes of first deviations corresponding to the first to-be-balanced battery packs, magnitudes of balancing currents of direct current/direct current conversion circuits connected to the first to-be-balanced battery packs.

When the energy storage module is charged and at least two second to-be-balanced battery packs exist, the method further includes the following step:

determining, based on magnitudes of first deviations corresponding to the second to-be-balanced battery packs, magnitudes of balancing currents of direct current/direct current conversion circuits connected to the second to-be-balanced battery packs, where the magnitudes of the balancing currents are positively correlated with the magnitudes of the first deviations.

The following describes a method for controlling an energy storage system to implement high-power balancing between battery clusters.

FIG. 10 is a flowchart of yet another balancing control method for an energy storage system according to an embodiment of this application.

In this embodiment, a second end of each power conversion circuit is connected to at least two battery clusters, buses of the at least two battery clusters are connected in parallel and are then connected to a balancing bus by using a controllable switch, and the method shown in the figure includes the following steps.

S1001: Determine that an average value of first parameter values of the at least two battery clusters is a second average value.

The first parameter value is a state of charge (SOC) value or a voltage value.

S1002: When a second deviation between a first parameter value of a battery cluster and the second average value is greater than a fourth preset threshold, control the controllable switch to be open.

S1003: Control a direct current/direct current conversion circuit of a battery cluster whose first parameter value is greater than the second average value to be a voltage source, control a direct current/direct current conversion circuit of a battery cluster whose first parameter value is less than the second average value to be a current source, and control a current to flow from the battery cluster whose first parameter value is greater than the second average value to the battery cluster whose first parameter value is less than the second average value.

The following describes another method for controlling an energy storage system to implement high-power balancing between battery clusters.

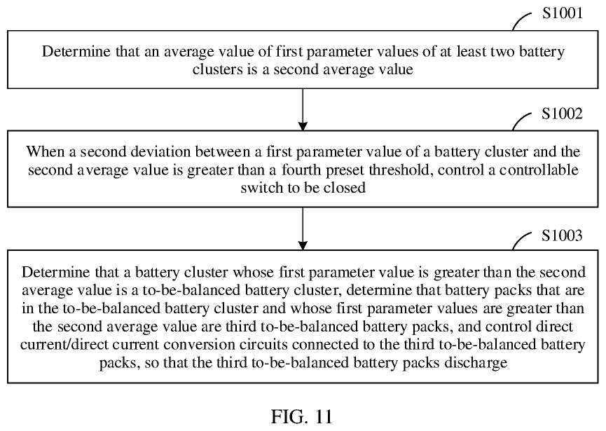

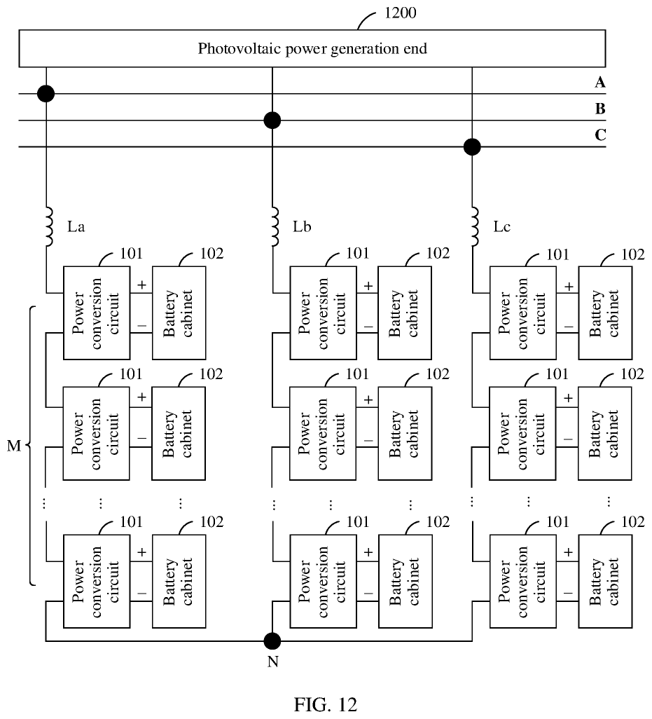

FIG. 11 is a flowchart of still yet another balancing control method for an energy storage system according to an embodiment of this application.

In this embodiment, a first parameter value is a state of charge (SOC) value, and the method includes the following steps:

S1101: Determine that an average value of first parameter values of at least two battery clusters is a second average value.

S1102: When a second deviation between a first parameter value of a battery cluster and the second average value is greater than a fourth preset threshold, control a controllable switch to be closed.

S1103: Determine that a battery cluster whose first parameter value is greater than the second average value is a to-be-balanced battery cluster, determine that battery packs that are in the to-be-balanced battery cluster and whose first parameter values are greater than the second average value are third to-be-balanced battery packs, and control direct current/direct current conversion circuits connected to the third to-be-balanced battery packs, so that the third to-be-balanced battery packs discharge.

When the direct current/direct current conversion circuits connected to the third to-be-balanced battery packs are controlled, S1103 includes the following steps:

obtaining third deviations between first parameter values of the third to-be-balanced battery packs and the second average value; and

determining, based on the third deviations, balancing currents of the direct current/direct current conversion circuits connected to the third to-be-balanced battery packs, where the magnitudes of the balancing currents of the direct current/direct current conversion circuits connected to the third to-be-balanced battery packs are positively correlated with the magnitudes of the corresponding third deviations.

In the foregoing control method, high-power balancing between a battery pack and a battery cluster and high-power balancing between battery clusters are implemented, and a balancing current greatly increases, so that an electric energy balancing capability is improved. Therefore, electric energy balancing can be quickly implemented, and impact on the energy storage system that is caused by a Cannikin law of batteries can be effectively alleviated.

Based on the energy storage system provided in the foregoing embodiments, an embodiment of this application further provides a photovoltaic power system. The following describes the photovoltaic power system in detail with reference to the accompanying drawings.

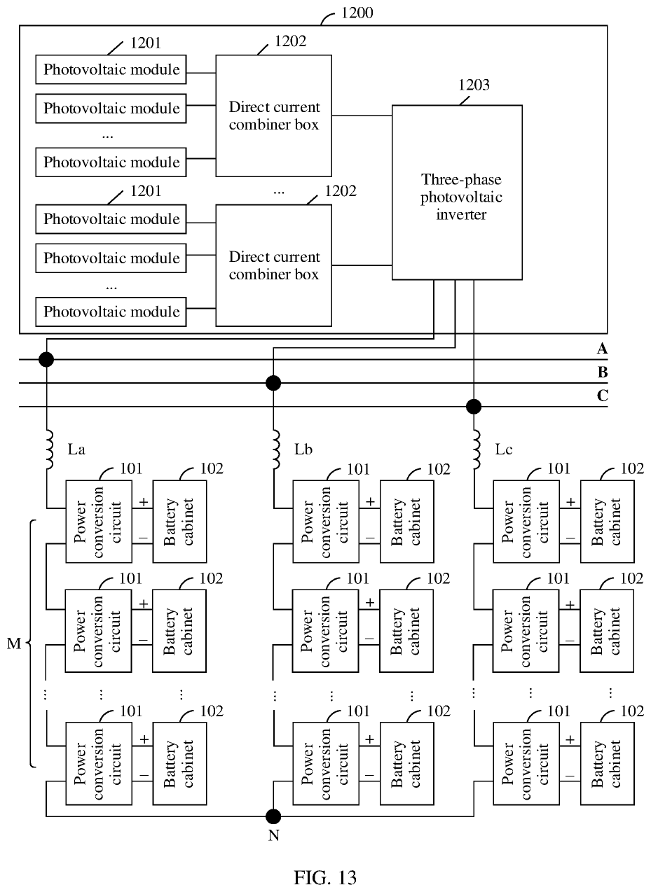

FIG. 12 is a schematic diagram of a photovoltaic power system according to an embodiment of this application.

The photovoltaic power system shown in the figure includes an energy storage system and a photovoltaic power generation end 1200.

The energy storage system includes three power conversion branches, and the energy storage system is configured to connect to a three-phase alternating current power network. For a specific implementation of the energy storage system, refer to related descriptions in the foregoing embodiments.

The photovoltaic power generation end 1200 includes a photovoltaic module and a three-phase photovoltaic inverter. The following describes a specific implementation of the photovoltaic power generation end.

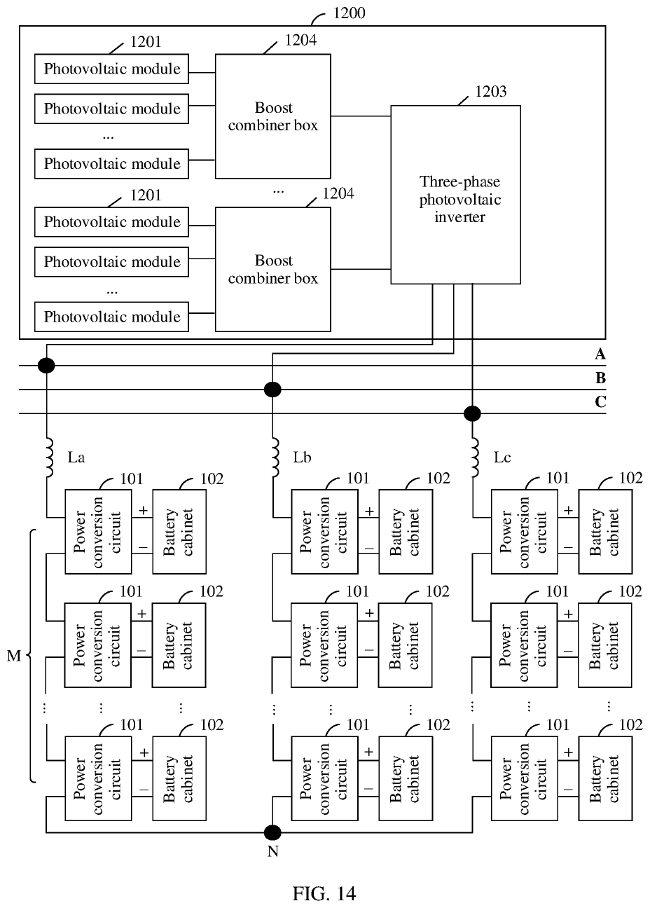

FIG. 13 is a schematic diagram of another photovoltaic power system according to an embodiment of this application.

A photovoltaic power generation end shown in the figure includes a photovoltaic module 1201, a direct current combiner box 1202, and a three-phase photovoltaic inverter 1203.

The photovoltaic module 1201 is configured to generate a direct current by using optical energy. An input end of the direct current combiner box 1202 is usually connected to a plurality of photovoltaic modules 1201, and an output end of the direct current combiner box 1202 is connected to the three-phase photovoltaic inverter 1203.

An output end of the three-phase photovoltaic inverter 1203 is connected to a three-phase alternating current bus. The three-phase alternating current bus is further connected to an energy storage system and an alternating current power network. The three-phase photovoltaic inverter 1203 is configured to: convert a direct current into a three-phase alternating current, and transmit the three-phase alternating current to the power network by using the three-phase alternating current bus or charge the energy storage system.

FIG. 14 is a schematic diagram of still another photovoltaic power system according to an embodiment of this application.

The photovoltaic power system shown in FIG. 14 differs from that in FIG. 13 in that a photovoltaic module 1201 first outputs a direct current to a boost combiner box 1204. The boost combiner box 1204 has a maximum power point tracking (MPPT) function, and is a direct current boost converter.

In actual application, there may be one or more three-phase photovoltaic inverters 1203 in the scenarios in FIG. 13 and FIG. 14. This is not specifically limited in embodiments of this application.

Because a photovoltaic power generation end 1200 is characterized by fluctuation and uncertainty, a power yield of the photovoltaic power generation end 1200 fluctuates. When an alternating current output by the photovoltaic power generation end 1200 is greater than an electrical requirement of an alternating current power network, excess electric energy is converted into a direct current by using a power conversion circuit 101 for charging a battery cluster. When an alternating current output by the photovoltaic power generation end 1200 is less than an electrical requirement of an alternating current power network, a power conversion circuit 101 converts, into an alternating current, a direct current output by a battery cluster, and then outputs the alternating current to the alternating current power network, so that the alternating current power network tends to be stable.

In an energy storage system of the photovoltaic power system, a balancing bus is added to a second end of the power conversion circuit, and each battery pack is connected to the balancing bus by using one direct current/direct current conversion circuit. A controller controls a working status of each direct current/direct current conversion circuit, so that electric energy of a battery pack is transferred to the balancing bus by using the direct current/direct current conversion circuit, and is then transferred from the balancing bus to another battery pack by using another direct current/direct current conversion circuit. In this way, electric energy of battery packs is balanced. Because battery pack-level electric energy balancing is performed, in comparison with a solution of performing passive balancing on batteries, a balancing current greatly increases and can reach a 100-ampere level, so that an electric energy balancing capability is improved. In addition, the controller simultaneously controls a plurality of direct current/direct current conversion circuits, so that electric energy balancing between a plurality of battery packs can be implemented, thereby further improving the electric energy balancing capability.

In conclusion, in the energy storage system provided in this embodiment of this application, battery pack-level electric energy balancing can be performed, so that an electric energy balancing capability is improved, and impact on the energy storage system that is caused by a Cannikin law of batteries is effectively alleviated.

It should be understood that, in this application, “at least one” means one or more, and “a plurality of” means two or more. The term “and/or” is used to describe an association relationship between associated objects, and indicates that three relationships may exist. For example, “A and/or B” may indicate the following three cases: Only A exists, only B exists, and both A and B exist, where A and B may be singular or plural. The character “/” generally indicates an “or” relationship between the associated objects. “At least one of the following items (pieces)” or a similar expression thereof indicates any combination of these items, including a single item (piece) or any combination of a plurality of items (pieces). For example, at least one of a, b, or c may indicate: a, b, c, “a and b”, “a and c”, “b and c”, or “a, b and c”, where a, b, and c each may be singular or plural.

The embodiments in this specification are all described in a progressive manner, for same or similar parts in the embodiments, refer to these embodiments, and each embodiment focuses on a difference from other embodiments. In addition, some or all of the units and modules may be selected based on an actual requirement to implement the objectives of the solutions of embodiments. A person of ordinary skill in the art may understand and implement the embodiments of this application without creative efforts.

The foregoing descriptions are merely specific implementations of this application. It should be noted that a person of ordinary skill in the art may make some improvements and polishing without departing from the principle of this application and the improvements and polishing shall fall within the protection scope of this application.

1. An energy storage system, comprising a controller and three power conversion branches, wherein
each of the three power conversion branches comprises one power conversion circuit, a first end of the power conversion circuit is connected to an alternating current bus; or
each of the three power conversion branches comprises at least two power conversion circuits connected in series, and first ends of the at least two power conversion circuits are connected in series and are then connected to an alternating current bus;
a second end of each power conversion circuit in each of the three power conversion branches is connected to at least one battery cluster;
each of the at least one battery cluster comprises at least two energy storage modules connected in series, each of the two energy storage modules comprises one direct current/direct current conversion circuit and one battery pack, and each battery pack comprises at least two batteries;
an output end of each battery pack is connected to an input end of a corresponding direct current/direct current conversion circuit, and an output end of each direct current/direct current conversion circuit is connected in parallel to a balancing bus;
the power conversion circuit is configured to: convert a direct current provided by the battery cluster into an alternating current and then transmit the alternating current to an alternating current power network, or convert an alternating current obtained from an alternating current power network into a direct current and then charge the battery cluster; and
the controller is configured to control each direct current/direct current conversion circuit, so that electric energy of battery packs in the battery cluster is balanced.

2. The energy storage system according to claim 1, wherein each battery pack for which a first deviation between a first parameter value and a first average value is greater than a first preset threshold is a first to-be-balanced battery pack, and a battery pack for which a first deviation between a first parameter value and a first average value is less than a second preset threshold is a second to-be-balanced battery pack; and
the controller is configured to: control a direct current/direct current conversion circuit connected to the first to-be-balanced battery pack and a direct current/direct current conversion circuit connected to the second to-be-balanced battery pack; and the first preset threshold is greater than the second preset threshold.

3. The energy storage system according to claim 2, further comprising a controllable switch, wherein
the balancing bus is connected to a bus of the battery cluster by using the controllable switch; and
the controller is further configured to control the controllable switch based on the first parameter values of the battery packs.

4. The energy storage system according to claim 3, wherein when the energy storage module discharges and a first to-be-balanced battery pack exists, the controller controls the controllable switch to be closed, controls a direct current/direct current conversion circuit corresponding to the first to-be-balanced battery pack to be a current source, and controls a current to flow from the first to-be-balanced battery pack to the bus of the battery cluster; and when the energy storage module is charged and a second to-be-balanced battery pack exists, the controller controls the controllable switch to be closed, controls a direct current/direct current conversion circuit corresponding to the second to-be-balanced battery pack to be a current source, and controls a current to flow from the bus of the battery cluster to the first to-be-balanced battery pack.

5. The energy storage system according to claim 4, wherein when the energy storage module discharges and at least two first to-be-balanced battery packs exist, the controller is further configured to determine, based on magnitudes of first deviations corresponding to the first to-be-balanced battery packs, magnitudes of balancing currents of direct current/direct current conversion circuits connected to the first to-be-balanced battery packs; when the energy storage module is charged and at least two second to-be-balanced battery packs exist, the controller is further configured to determine, based on magnitudes of first deviations corresponding to the second to-be-balanced battery packs, magnitudes of balancing currents of direct current/direct current conversion circuits connected to the second to-be-balanced battery packs; and the magnitudes of the balancing currents are positively correlated with the magnitudes of the first deviations.

6. The energy storage system according to claim 1, wherein the controller is configured to: obtain a difference between a maximum value and a minimum value in first parameter values of battery packs; when the difference is greater than or equal to a third preset threshold, determine that a battery pack with a maximum first parameter value is a first to-be-balanced battery pack; determine that a battery pack with a minimum first parameter value is a second to-be-balanced battery pack; and control a direct current/direct current conversion circuit connected to the first to-be-balanced battery pack and a direct current/direct current conversion circuit connected to the second to-be-balanced battery pack.

7. The energy storage system according to claim 6, further comprising a controllable switch, wherein
the balancing bus is connected to a bus of the battery cluster by using the controllable switch; and
the controller is further configured to control the controllable switch based on the first parameter values of the battery packs.

8. The energy storage system according to claim 7, wherein when the energy storage module discharges and a first to-be-balanced battery pack exists, the controller controls the controllable switch to be closed, controls a direct current/direct current conversion circuit corresponding to the first to-be-balanced battery pack to be a current source, and controls a current to flow from the first to-be-balanced battery pack to the bus of the battery cluster; and when the energy storage module is charged and a second to-be-balanced battery pack exists, the controller controls the controllable switch to be closed, controls a direct current/direct current conversion circuit corresponding to the second to-be-balanced battery pack to be a current source, and controls a current to flow from the bus of the battery cluster to the first to-be-balanced battery pack.

9. The energy storage system according to claim 2, wherein the second end of each power conversion circuit is connected to at least two battery clusters; and
buses of the at least two battery clusters are connected in parallel and are then connected to the balancing bus by using the controllable switch.

10. The energy storage system according to claim 9, wherein the controller is further configured to: determine that an average value of first parameter values of the at least two battery clusters is a second average value; and when a second deviation between the first parameter value of the battery cluster and the second average value is greater than a fourth preset threshold, control the controllable switch to be open, control a direct current/direct current conversion circuit of the battery cluster whose first parameter value is greater than the second average value to be a voltage source, control a direct current/direct current conversion circuit of the battery cluster whose first parameter value is less than the second average value to be a current source, and control a current to flow from the battery cluster whose first parameter value is greater than the second average value to the battery cluster whose first parameter value is less than the second average value.

11. The energy storage system according to claim 2, wherein the first parameter value is a state of charge (SOC) value or a voltage value.

12. The energy storage system according to claim 9, wherein the first parameter value is a state of charge (SOC) value, and the controller is further configured to: determine that an average value of first parameter values of the at least two battery clusters is a second average value; and when a second deviation between a first parameter value of a battery cluster and the second average value is greater than a fourth preset threshold, control the controllable switch to be closed, determine that a battery cluster whose first parameter value is greater than the second average value is a to-be-balanced battery cluster, determine that battery packs that are in the to-be-balanced battery cluster and whose first parameter values are greater than the second average value are third to-be-balanced battery packs, and control direct current/direct current conversion circuits connected to the third to-be-balanced battery packs, so that the third to-be-balanced battery packs discharge.

13. The energy storage system according to claim 12, wherein the controller is further configured to obtain third deviations between first parameter values of the third to-be-balanced battery packs and the second average value; and determine, based on the third deviations, balancing currents of the direct current/direct current conversion circuits connected to the third to-be-balanced battery packs, wherein magnitudes' of the balancing currents of the direct current/direct current conversion circuits connected to the third to-be-balanced battery packs is positively correlated with magnitudes' of the corresponding third deviations.

14. The energy storage system according to claim 2, wherein the controller comprises at least one first control unit and at least one second control unit;
a quantity the at least one second control unit is the same as a quantity of battery packs in the battery cluster;
each of the at least one second control unit is configured to: obtain a first parameter value of one battery pack; send the first parameter value to one of the at least one first control unit; and control one corresponding direct current/direct current conversion circuit according to a control instruction sent by the first control unit; and
each of the at least one first control unit is configured to: determine the first to-be-balanced battery pack and the second to-be-balanced battery pack based on obtained first parameter values;
and send control instructions to at least one second control unite.

15. The energy storage system according to claim 1, wherein the energy storage system further comprises a three-phase alternating current bus, a first end of each power conversion branch is connected to a one-phase alternating current bus, and second ends of the three power conversion branches are connected to each other.

16. The energy storage system according to claim 1, wherein the energy storage system further comprises a three-phase alternating current bus, and the three power conversion branches are separately connected between alternating current buses of every two phases.

17. The energy storage system according to claim 1, wherein a voltage of the balancing bus is less than or equal to an output voltage of the battery cluster, and is greater than a voltage output by the battery pack to the direct current/direct current conversion circuit.

18. A balancing control method for an energy storage system, wherein the energy storage system comprises three power conversion branches, each of the three power conversion branches comprises one power conversion circuit, and a first end of the power conversion circuit is connected to an alternating current bus; or each power conversion branch comprises at least two power conversion circuits connected in series, and first ends of the at least two power conversion circuits are connected in series and are then connected to an alternating current bus; a second end of each power conversion circuit in each of the three power conversion branches is connected to at least one battery cluster; each of the at least one battery cluster comprises at least two energy storage modules connected in series, each of the at least two energy storage modules comprises one direct current/direct current conversion circuit and one battery pack, and each battery pack comprises at least two batteries; an output end of each battery pack is connected to an input end of a corresponding direct current/direct current conversion circuit, and an output end of each direct current/direct current conversion circuit is connected in parallel to a balancing bus; and the method comprises:
controlling each direct current/direct current conversion circuit, so that electric energy of battery packs in the battery cluster is balanced.

19. The balancing control method according to claim 18, wherein each battery pack for which a first deviation between a first parameter value and a first average value is greater than a first preset threshold is a first to-be-balanced battery pack, and a battery pack for which a first deviation between a first parameter value and a first average value is less than a second preset threshold is a second to-be-balanced battery pack, wherein the first preset threshold is greater than the second preset threshold; and
controlling each direct current/direct current conversion circuit comprises controlling a direct current/direct current conversion circuit connected to the first to-be-balanced battery pack and a direct current/direct current conversion circuit connected to the second to-be-balanced battery pack, so that the electric energy of the battery packs in the battery cluster is balanced.

20. The balancing control method according to claim 19, wherein the energy storage system further comprises a controllable switch, a balancing bus is connected to a bus of the battery cluster by using the controllable switch, and the method further comprises:
when an energy storage module discharges and a first to-be-balanced battery pack exists, controlling the controllable switch to be closed, controlling a direct current/direct current conversion circuit corresponding to the first to-be-balanced battery pack to be a current source, and controlling a current to flow from the first to-be-balanced battery pack to the bus of the battery cluster; and
when the energy storage module is charged and a second to-be-balanced battery pack exists, controlling the controllable switch to be closed, controlling a direct current/direct current conversion circuit corresponding to the second to-be-balanced battery pack to be a current source, and controlling a current to flow from the bus of the battery cluster to the first to-be-balanced battery pack.
